(19) United States
(12) Patent Application Publication
(10) Pub. No.: US 2025/0370118 A1
(43) Pub. Date: Dec. 4, 2025

(54) OBJECT DETECTION APPARATUS

(71) Applicant: Mitsubishi Electric Corporation, Tokyo (JP)

(72) Inventor: Tatsuya KAMIMURA, Tokyo (JP)

(73) Assignee: Mitsubishi Electric Corporation, Tokyo (JP)

(21) Appl. No.: 18/873,473

(22) PCT Filed: Jun. 21, 2022
(86) PCT No.: PCT/JP2022/024708

§ 371 Date: Dec. 10, 2024

(51) Int. Cl. G01S 13/52; G01S 13/72; G01S 13/86; G01S 13/931

(52) U.S. Cl. CPC G01S 13/52; G01S 13/723; G01S 13/867; G01S 13/931; G01S 2013/932

(57) ABSTRACT

An object detection apparatus includes: a radar signal processor that detects radar detection positions and radar detection speeds of objects; a camera image processor that detects camera detection positions and object types of some of the objects; and a fusion processor that outputs the radar detection position, the radar detection speed, and the object type of the object to a vehicle control device, a position of the object indicated by the radar detection position being identical to a position of the object indicated by the camera detection position, wherein the radar signal processor determines the stationary object based on the radar detection positions, the camera detection position of the moving object, and the object type of the moving object, calculates an own vehicle speed based on the radar detection speed of the stationary object, and causes the radar to track the objects based on the own vehicle speed.

### FIELD

The present disclosure relates to an object detection apparatus that detects an object from a vehicle.

### BACKGROUND

An object detection apparatus to be installed in a vehicle is an apparatus capable of detecting, in a short time, an object such as a person or an obstacle existing in a use environment of the vehicle. This object detection apparatus can achieve safe vehicle driving by using a vehicle control function or an alarm notification function and an object detection function. Examples of object detection apparatus to be installed in a vehicle include various types of apparatus using a radar, a camera, a Light Detection And Ranging (LiDAR), and an ultrasonic sensor. In recent years, with the spread of various sensors, a fusion-type object detection apparatus has been widely used which improves performance by combining a plurality of sensors.

The object detection apparatus described in Patent Literature 1 is a fusion-type object detection apparatus using a radar and a camera, and determines whether an object is a pedestrian from position data on the object detected by use of the radar and the camera.

### CITATION LIST

### Patent Literature

Patent Literature 1: WO 2010/119860 A

### SUMMARY OF INVENTION

### Problem to be Solved by the Invention

However, the technique of Patent Literature 1 described above has a problem in that since the speed of an own vehicle is not used when an object is detected by the radar, performance of the radar in tracking the object is lowered and thus, the object cannot be accurately detected in some cases.

The present disclosure has been made in view of the above, and an object of the present disclosure is to obtain an object detection apparatus capable of accurately detecting an object.

### Means to Solve the Problem

In order to solve the above-described problem and achieve the object, an object detection apparatus of the present disclosure includes: a radar that emits electromagnetic waves and receives reflected signals from objects including a moving object and a stationary object; and a camera that acquires image data on the objects by imaging the objects. Furthermore, the object detection apparatus of the present disclosure includes: a radar signal processing unit that detects radar detection positions and radar detection speeds by performing signal processing on the reflected signals, the radar detection positions being positions of the objects, the radar detection speeds being speeds of the objects; and a camera image processing unit that detects camera detection positions and object types based on the image data, the camera detection positions being positions of the objects, the object types being types of some of the objects. In addition, the object detection apparatus of the present disclosure includes a fusion processing unit that determines whether a position indicated by the radar detection position is identical to a position indicated by the camera detection position, and outputs the radar detection position, the radar detection speed, and the object type of the object to an external device, identity of the object having been determined. The camera image processing unit detects the camera detection position of the moving object and the object type of the moving object. The radar signal processing unit determines the stationary object among the objects based on the radar detection positions, the camera detection position of the moving object, and the object type of the moving object; calculates a speed of an own vehicle as an own vehicle speed based on the radar detection speed of the stationary object, the own vehicle being a vehicle in which an own apparatus is installed; and causes the radar to track the moving object and the stationary object based on the own vehicle speed.

### Effects of the Invention

The object detection apparatus according to the present disclosure has an effect of enabling an object to be accurately detected.

### BRIEF DESCRIPTION OF DRAWINGS

FIG. 1 is a diagram illustrating a configuration of an object detection apparatus according to an embodiment.

FIG. 2 is a flowchart illustrating a procedure of a process in which the object detection apparatus according to the embodiment detects objects.

FIG. 3 is a diagram for describing objects to be detected by the object detection apparatus according to the embodiment.

FIG. 4 is a diagram for describing positions and speeds of the objects detected by the object detection apparatus according to the embodiment.

FIG. 5 is a diagram illustrating an exemplary configuration of processing circuitry included in the object detection apparatus according to the embodiment, the processing circuitry being implemented by a processor and a memory.

FIG. 6 is a diagram showing an example of the processing circuitry included in the object detection apparatus according to the embodiment, the processing circuitry including dedicated hardware.

### DESCRIPTION OF EMBODIMENTS

Hereinafter, an object detection apparatus according to an embodiment of the present disclosure will be described in detail with reference to the drawings.

### Embodiment

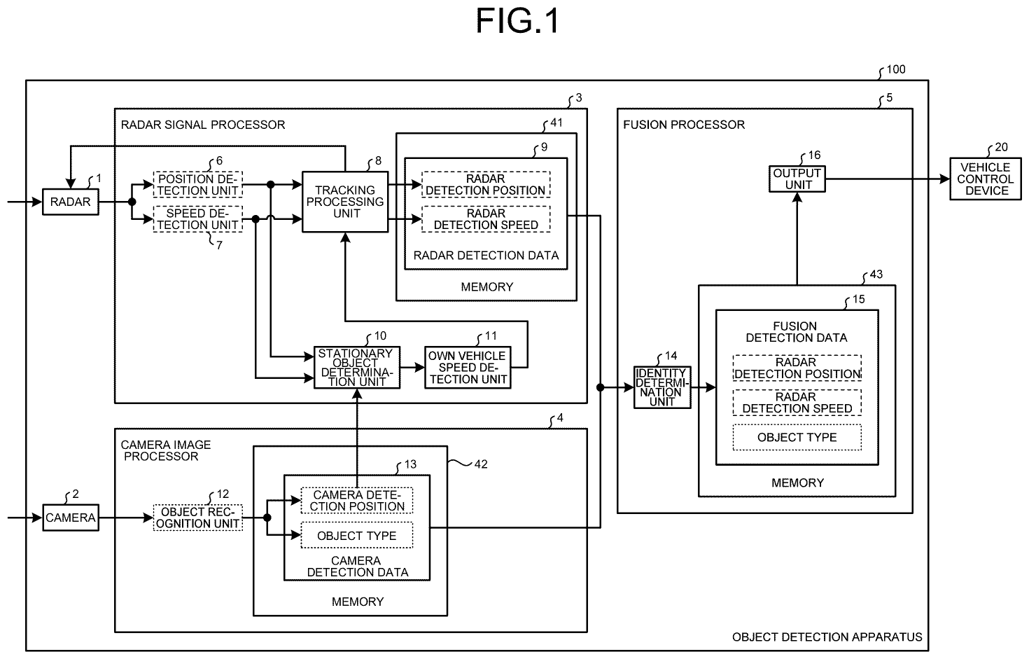

FIG. 1 is a diagram illustrating a configuration of an object detection apparatus according to an embodiment. An object detection apparatus 100 to be installed in a vehicle is a fusion-type object detection apparatus, and detects an object by using a radar 1 and a camera 2.

The object detection apparatus 100 detects an object by using the camera 2 to improve accuracy of detection by the radar 1 which is one of sensors. The object detection apparatus 100 detects the speed of a vehicle (hereinafter, referred to as “own vehicle”) in which the object detection apparatus 100 is installed with high accuracy by using the radar 1 and the camera 2 in combination, and improves accuracy of object tracking processing to be performed by the radar 1. Thus, the object detection apparatus 100 detects an object with high accuracy.

The object detection apparatus 100 includes the radar 1, the camera 2, a radar signal processor 3, a camera image processor 4, and a fusion processor 5. The radar signal processor 3 serves as a radar signal processing unit. The camera image processor 4 serves as a camera image processing unit. The fusion processor 5 serves as a fusion processing unit.

The camera 2 includes components such as a lens, a holder, a complementary metal oxide semiconductor (CMOS) sensor, a power-supply semiconductor component, and a crystal device. The camera 2 acquires image data (image information) on an object by imaging the object, and outputs the image data to the camera image processor 4.

The camera image processor 4 detects data such as the position of the object and the type of the object (hereinafter, referred to as an object type) on the basis of the image data. A micro control unit (MCU), a central processing unit (CPU), a graphics processing unit (GPU), or the like is used as the camera image processor 4. The camera image processor 4 includes an object recognition unit 12 and a memory 42.

The object recognition unit 12 is connected to the camera 2, and receives image data from the camera 2. The object recognition unit 12 uses a database of feature data (feature amount) obtained by machine learning, deep learning, or the like. The object recognition unit 12 recognizes an object, such as a person or an obstacle, and detects an object type on the basis of the feature data in the database and the image data from the camera 2. Specifically, the object recognition unit 12 extracts feature data from the image data, and compares the feature data with feature data obtained by deep learning or the like. Thus, the object recognition unit 12 recognizes an object, and detects an object type.

The object recognition unit 12 detects an object type for a specific moving object set in advance. The object recognition unit 12 picks out, for example, a walking person or a moving bicycle as a moving object, and detects an object type of the moving object picked out.

Furthermore, the object recognition unit 12 detects a position (hereinafter, referred to as a camera detection position) of an object on the basis of coordinates of the object included in the image data. The object recognition unit 12 stores, in the memory 42, the object type and the camera detection position as camera detection data 13 serving as object recognition data.

The camera image processor 4 outputs the camera detection data 13 including the object type and the camera detection position to the radar signal processor 3. Since the object to be recognized by the object recognition unit 12 is a moving object, the camera image processor 4 outputs, to the radar signal processor 3, the camera detection data 13 including the object type and camera detection position of the moving object.

The radar 1 emits electromagnetic waves to an object such as a person or an obstacle, and receives a reflected signal from the object. The radar 1 outputs the reflected signal to the radar signal processor 3. The radar 1 receives reflected signals from both a moving object and a stationary object.

The radar signal processor 3 detects positions and speeds of the objects by performing signal processing on the reflected signals (reception signals) received by the radar 1. Since the radar 1 is disposed in the object detection apparatus 100 to be installed in a vehicle, the radar 1 detects an object by using a Frequency Modulated Continuous Wave (FMCW) method, a Fast Chirp Modulation (FCM) method, or the like. The radar 1 includes a high-frequency semiconductor component, a power-supply semiconductor component, a substrate, a crystal device, a chip component, an antenna, and the like.

An MCU, a CPU, or the like is used as the radar signal processor 3. The radar signal processor 3 includes a position detection unit 6, a speed detection unit 7, a tracking processing unit 8, a memory 41, a stationary object determination unit 10, and an own vehicle speed detection unit 11.

The position detection unit 6 and the speed detection unit 7 are connected to the radar 1, and receive reflected signals from the radar 1. The position detection unit 6 and the speed detection unit 7 perform, on the reflected signals, arithmetic processing using fast Fourier transformation (FFT). Specifically, the position detection unit 6 and the speed detection unit 7 detect the positions and speeds of the objects by performing the fast Fourier transformation on the reflected signals in a distance direction, a speed direction, and a horizontal-angle direction. The position detection unit 6 outputs the positions of the objects (position data) as radar detection positions to the stationary object determination unit 10 and the tracking processing unit 8. The speed detection unit 7 outputs the speeds of the objects (speed data) as radar detection speeds to the stationary object determination unit 10 and the tracking processing unit 8.

The stationary object determination unit 10 determines whether objects present in a field in which the object detection apparatus 100 is used are stationary objects. The stationary object determination unit 10 determines a moving object included in the objects on the basis of radar detection positions, camera detection positions, and object types. The stationary object determination unit 10 picks out a radar detection speed corresponding to a stationary object by removing a radar detection speed corresponding to the moving object from the radar detection speeds. The stationary object determination unit 10 determines a radar detection speed of a stationary object by deleting only data corresponding to the moving object from multiple pieces of data (radar detection positions and radar detection speeds) on the objects.

Specifically, the stationary object determination unit 10 picks out an object type that is the same as a specific object type set in advance and a camera detection position corresponding to the object type from camera detection positions and object types detected by the camera image processor 4. The stationary object determination unit 10 picks out, as data on a stationary object, a radar detection speed corresponding to a radar detection position indicating a position that is the same as the camera detection position that has been picked out, from the radar detection positions.

Specifically, the stationary object determination unit 10 determines that an object at a camera detection position corresponding to the object type is a moving object. Then, the stationary object determination unit 10 removes detection data on the object judged to be a moving object from the detection data that is transmitted from the position detection unit 6 and the speed detection unit 7. That is, the stationary object determination unit 10 removes, as detection data on a moving object, detection data on an object for which a radar detection position transmitted from the position detection unit 6 and the speed detection unit 7 and a camera detection position indicate the same position. The stationary object determination unit 10 determines a radar detection speed of a stationary object by deleting only data corresponding to the moving object from the multiple pieces of detection data (radar detection positions and radar detection speeds) that are transmitted from the position detection unit 6 and the speed detection unit 7.

The stationary object determination unit 10 outputs the radar detection position of the stationary object and the radar detection speed of the stationary object to the own vehicle speed detection unit 11.

A moving object to be detected by the camera image processor 4 corresponds to a person, another vehicle, or the like. When an own vehicle, which is a vehicle in which the object detection apparatus 100 is installed, is moving, a relative speed is assigned to a stationary object. That is, when the own vehicle is moving, the object detection apparatus 100 detects, as the speed of a stationary object, a speed of the stationary object relative to the object detection apparatus 100. Therefore, it is difficult for the object detection apparatus 100 to distinguish between a moving object and a stationary object only with the radar 1. Meanwhile, the object detection apparatus 100 of the present embodiment can easily determine whether an object is a stationary object by using the radar 1 and the camera 2 in combination.

The own vehicle speed detection unit 11 calculates a speed (hereinafter, referred to as an own vehicle speed) of the own vehicle by averaging radar detection speeds transmitted from the stationary object determination unit 10. The own vehicle speed detection unit 11 outputs the own vehicle speed as a detection result to the tracking processing unit 8.

The tracking processing unit 8 performs processing for tracking the moving object and the stationary object with different parameters on the basis of the radar detection positions and the radar detection speeds transmitted from the position detection unit 6 and the speed detection unit 7, and the own vehicle speed transmitted from the own vehicle speed detection unit 11.

Specifically, the tracking processing unit 8 distinguishes objects into a moving object and a stationary object, on the basis of the radar detection positions, the radar detection speeds, and the own vehicle speed. Then, the tracking processing unit 8 causes the radar 1 to track the moving object and the stationary object with different parameters based on the own vehicle speed.

The tracking processing unit 8 smooths the radar detection positions and the radar detection speeds transmitted from the position detection unit 6 and the speed detection unit 7 on the basis of the own vehicle speed. In addition, the tracking processing unit 8 estimates a radar detection position and a radar detection speed in a next frame on the basis of the own vehicle speed. Furthermore, the tracking processing unit 8 assigns identification information to the radar detection position and the radar detection speed. The tracking processing unit 8 stores, in the memory 41, the radar detection position and the radar detection speed used for tracking processing, as radar detection data 9.

The fusion processor 5 acquires, from the radar signal processor 3, the radar detection position and the radar detection speed detected by the radar 1. In addition, the fusion processor 5 acquires the object type and the camera detection position from the camera image processor 4. The fusion processor 5 performs data processing by using the radar detection position, the radar detection speed, the object type, and the camera detection position, and outputs, to an external device (for example, a vehicle control device 20), a data processing result as a result of detection performed by the object detection apparatus 100. That is, the fusion processor 5 performs data processing on the position, speed, and object type of the moving object, and outputs the data processing result to the external device.

The fusion processor 5 includes an identity determination unit 14, a memory 43, and an output unit 16. The identity determination unit 14 determines identity of an object based on the radar detection position and the camera detection position. Specifically, the identity determination unit 14 performs an identity determination process that is a process of determining whether an object indicated by the radar detection position is identical to an object indicated by the camera detection position on the basis of whether a position of the object indicated by the radar detection position is identical to a position of the object indicated by the camera detection position. In this identity determination process, the identity determination unit 14 associates the radar detection position acquired by use of the radar 1, the radar detection speed acquired by use of the radar 1, and the object type acquired by use of the camera 2 with each other.

The identity determination unit 14 stores, in the memory 43, data in which the radar detection position, the radar detection speed, and the object type are associated with each other, as fusion detection data 15. Since the object type determined by use of the camera 2 is a moving object, the identity determination unit 14 stores, in the memory 43, data in which the radar detection position of the moving object, the radar detection speed of the moving object, and the object type of the moving object are associated with each other as the fusion detection data 15.

The output unit 16 outputs the fusion detection data 15, in which the radar detection position, the radar detection speed, and the object type are associated with each other, to the vehicle control device 20 which is a device connected on a stage subsequent to the object detection apparatus 100. In this manner, the fusion processor 5 transfers the fusion detection data 15 including the radar detection position, the radar detection speed, and the object type to the vehicle control device 20. As a result, the vehicle control device 20 installed in the own vehicle uses the fusion detection data 15 for controlling the own vehicle. That is, the vehicle control device 20 controls the own vehicle based on the position, speed, and type of the moving object. Note that the output unit 16 may be disposed outside the fusion processor 5.

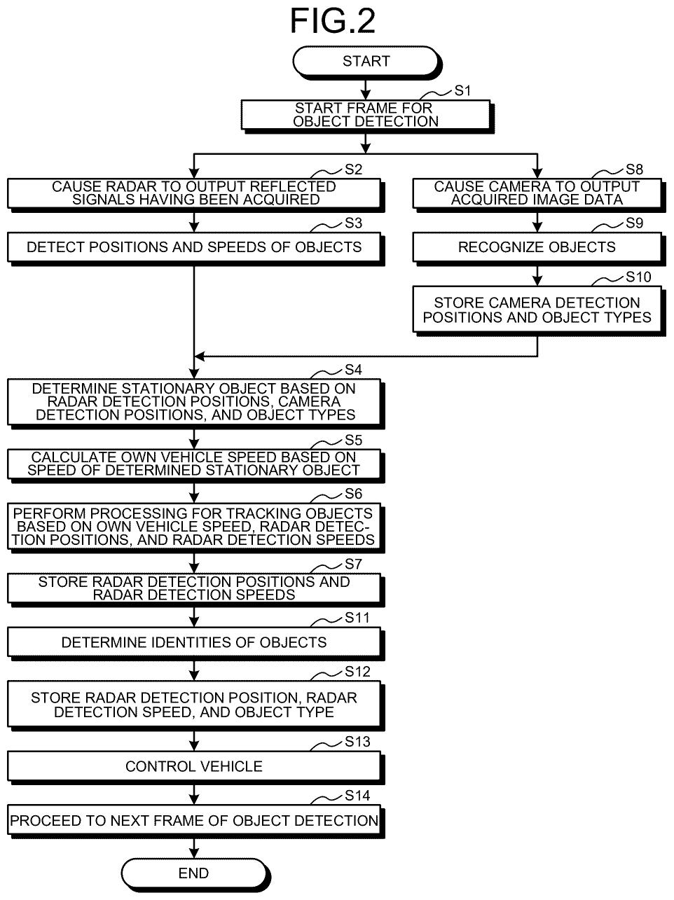

Next, a procedure of object detection to be performed by the object detection apparatus 100 will be described. FIG. 2 is a flowchart illustrating a procedure of a process in which the object detection apparatus according to the embodiment detects objects. When the object detection apparatus 100 to be installed in a vehicle starts a frame for object detection (step S1), the radar 1 outputs reflected signals that are acquired from objects to the radar signal processor 3 (step S2), and the camera 2 outputs acquired image data to the camera image processor 4 (step S8).

In the radar signal processor 3, the position detection unit 6 and the speed detection unit 7 detect positions and speeds of the objects (step S3). The position detection unit 6 outputs, as radar detection positions, the positions of the objects detected by use of the radar 1 to the stationary object determination unit 10 and the tracking processing unit 8. The speed detection unit 7 outputs, as radar detection speeds, the speeds of the objects detected by use of the radar 1 to the stationary object determination unit 10 and the tracking processing unit 8.

In the camera image processor 4, the object recognition unit 12 recognizes the objects on the basis of the image data (step S9), and detects object types. Furthermore, the object recognition unit 12 detects camera detection positions, which are positions of the objects, on the basis of coordinates of the objects included in the image data.

The camera image processor 4 stores, in the memory 42, the camera detection positions and the object types as the camera detection data 13 (step S10). That is, the camera image processor 4 outputs the camera detection positions and the object types to the memory 42, and stores, in the memory 42, the camera detection positions and the object types as the camera detection data 13. The camera image processor 4 outputs the camera detection data 13 in the memory 42 to the radar signal processor 3 and the fusion processor 5.

The stationary object determination unit 10 of the radar signal processor 3 determines a stationary object among the objects on the basis of the radar detection positions, the camera detection positions, and the object types (step S4).

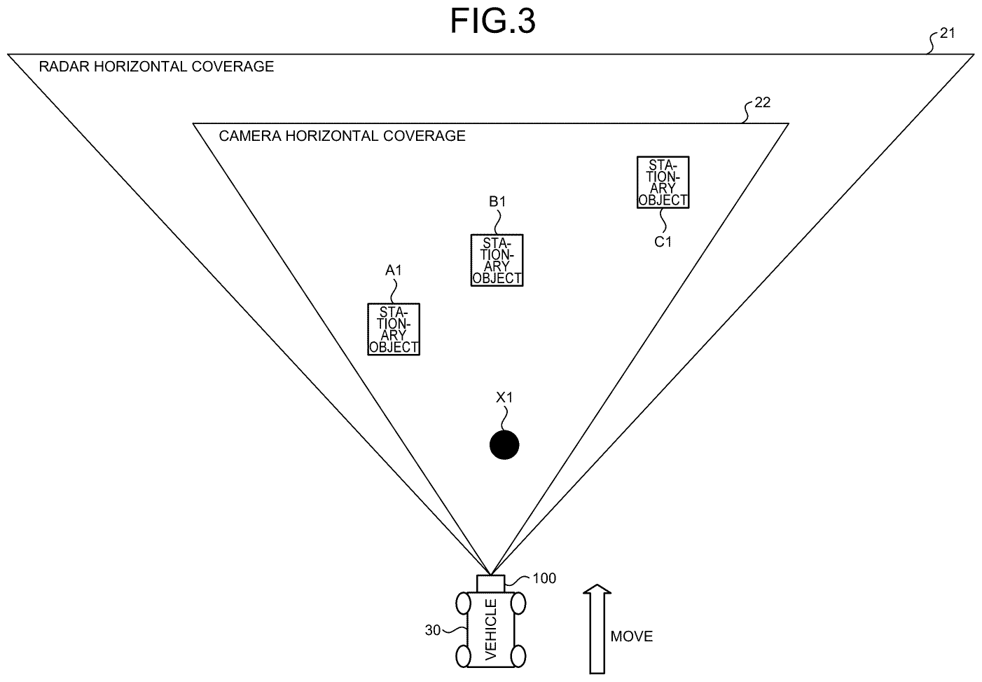

Here, a method for determining a stationary object will be described. FIG. 3 is a diagram for describing objects to be detected by the object detection apparatus according to the embodiment. Here, a description will be given of a case where the object detection apparatus 100 is installed in a vehicle 30, which is the own vehicle, and objects are located in front of the vehicle 30 (moving direction). The objects include a stationary object and a moving object. FIG. 3 illustrates a case where stationary objects A1 to C1 and a moving object X1 are located in front of the vehicle 30.

The object detection apparatus 100 detects objects while the vehicle 30 is moving. The radar 1 receives reflected signals from the objects located in front of the vehicle 30 in the moving direction. The camera 2 acquires image data from the objects located in front of the vehicle 30 in the moving direction.

An area included in both radar horizontal coverage 21, which is horizontal coverage of the radar 1, and camera horizontal coverage 22, which is horizontal coverage of the camera 2, is a field in which the object detection apparatus 100 detects objects. In FIG. 3, the stationary objects A1 to C1 and the moving object X1 are located in the radar horizontal coverage 21 and the camera horizontal coverage 22. Therefore, both the position detection unit 6 and the speed detection unit 7 of the radar signal processor 3 can detect the stationary objects A1 to C1 and the moving object X1. In addition, the object recognition unit 12 of the camera image processor 4 can detect the moving object X1.

When the stationary object determination unit 10 determines a stationary object, the own vehicle speed detection unit 11 calculates an own vehicle speed based on a speed of the determined stationary object (step S5). Specifically, the own vehicle speed detection unit 11 calculates an own vehicle speed by averaging radar detection speeds of the stationary objects A1 to C1 transmitted from the stationary object determination unit 10. In this manner, the object detection apparatus 100 can calculate the own vehicle speed based on the radar detection speeds of the stationary objects A1 to C1.

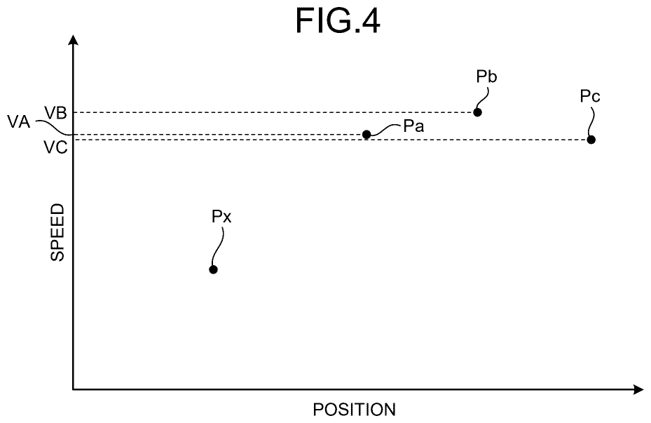

FIG. 4 is a diagram for describing positions and speeds of the objects detected by the object detection apparatus according to the embodiment. FIG. 4 is an image diagram in which positions and speeds detected from the objects illustrated in FIG. 3 are plotted, the positions and speeds having been detected by the position detection unit 6 and the speed detection unit 7 of the radar signal processor 3. In FIG. 4, the positions and speeds of the stationary objects A1 to C1 are denoted by Pa to Pc, and the position and speed of the moving object X1 are denoted by Px.

When the vehicle 30 is moving, all the stationary objects A1 to C1 and the moving object X1 have speeds as viewed from the object detection apparatus 100. That is, when the vehicle 30 moves, the radar signal processor 3 detects that the stationary objects A1 to C1 and the moving object X1 have speeds relative to the vehicle 30.

In addition, the camera image processor 4 detects camera detection positions and object types. Then, the stationary object determination unit 10 of the radar signal processor 3 detects the moving object X1 on the basis of the radar detection positions, the camera detection positions, and the object types. The stationary object determination unit 10 picks out the stationary objects A1 to C1 from the objects by omitting the moving object X1 from stationary object candidates.

For example, assuming that VA, VB, and VC denote speeds of the stationary objects A1, B1, and C1, respectively, which are judged to be stationary objects by the radar signal processor 3, the own vehicle speed detection unit 11 calculates an own vehicle speed Vcar by using formula (1) below.

$$Vcar = ( VA + VB + VC ) / 3 \qquad ( 1 )$$

In this manner, the object detection apparatus 100 calculates the speeds of the stationary objects relative to the vehicle 30, and calculates the own vehicle speed based on the relative speeds.

Note that the case where the object detection apparatus 100 calculates the own vehicle speed based on the average of the speeds of the stationary objects has been described in the present embodiment; however, the object detection apparatus 100 may adopt, as the own vehicle speed, a minimum value, a maximum value, a median, or the like of the speeds of the stationary objects.

After calculating the own vehicle speed, the radar signal processor 3 performs processing for tracking the objects on the basis of the own vehicle speed. Specifically, the tracking processing unit 8 performs processing for tracking the objects on the basis of the own vehicle speed, the radar detection positions, and the radar detection speeds (step S6). The tracking processing unit 8 performs processing for tracking the moving object and the stationary object with different parameters to each other on the basis of the own vehicle speed, the radar detection positions, and the radar detection speeds.

The tracking processing unit 8 stores, as the radar detection data 9, the radar detection positions and the radar detection speeds used for the tracking processing in the memory 41 (step S7). That is, the tracking processing unit 8 outputs the radar detection positions and the radar detection speeds to the memory 41, and stores, in the memory 41, the radar detection positions and the radar detection speeds as the radar detection data 9. The radar signal processor 3 outputs the radar detection data 9 in the memory 41 to the fusion processor 5.

The identity determination unit 14 of the fusion processor 5 acquires the radar detection positions and the radar detection speeds from the radar signal processor 3. The identity determination unit 14 determines identities of the objects based on the radar detection positions and the camera detection positions (step S11). The identity determination unit 14 performs an identity determination process that is a process of determining whether an object indicated by the radar detection position is identical to an object indicated by the camera detection position on the basis of whether a position of the object indicated by the radar detection position is identical to a position of the object indicated by the camera detection position.

In this manner, the identity determination unit 14 determines identities of the objects on the basis of the radar detection positions and the camera detection positions so as to associate the radar detection positions, the radar detection speeds, and the object types with various data transmitted to the fusion processor 5.

The identity determination unit 14 associates the radar detection position, the radar detection speed, and the object type with the object (mobile object) identity of which has been determined. The identity determination unit 14 stores, in the memory 43, data in which the radar detection position, the radar detection speed, and the object type are associated with each other as the fusion detection data 15 (step S12). That is, the identity determination unit 14 outputs, to the memory 43, data in which the radar detection position, the radar detection speed, and the object type are associated with each other, and stores the data as the fusion detection data 15 in the memory 43.

The position and speed data stored as part of the fusion detection data 15 in the memory 43 by the identity determination unit 14 correspond to the radar detection position and the radar detection speed detected by use of the radar 1. In addition, the object type stored as part of the fusion detection data 15 in the memory 43 by the identity determination unit 14 corresponds to data detected by use of the camera 2.

The output unit 16 of the fusion processor 5 outputs the fusion detection data 15 in the memory 43 to the vehicle control device 20. As a result, the fusion detection data 15 are used by the vehicle control device 20 for controlling the vehicle 30 (step S13). As described above, the object detection frame is completed, and the process proceeds to a next frame of object detection (step S14). Thus, the same processing is repeatedly performed from steps S1 to S14.

If the speed of the own vehicle is unknown, the tracking processing unit 8 of the radar signal processor 3, which processes detection data obtained by the radar 1, cannot determine whether an object to be detected is a moving object or a stationary object. Thus, the tracking processing performance of the tracking processing unit 8 is deteriorated. In the present embodiment, the stationary object determination unit 10 detects a moving object on the basis of the positions (camera detection positions) and object types of objects obtained by the camera 2 and the camera image processor 4, and deletes data on the moving object from data on the objects detected by the radar 1. Thus, the stationary object determination unit 10 can extract only data on a stationary object with high accuracy. As a result, the own vehicle speed detection unit 11 can detect the own vehicle speed with high accuracy. Therefore, the tracking processing unit 8 can determine a moving object and a stationary object with high accuracy based on the own vehicle speed. As a result, the accuracy of tracking processing is improved, and performance in object detection by means of the radar 1 is improved. As described above, the object detection apparatus 100, which is a fusion-type object detection apparatus adopting detection data obtained by the radar 1, can improve object detection performance.

Note that, among object detection apparatuses, there is an apparatus that acquires speed information on an own vehicle from the own vehicle in which the object detection apparatus is installed, and reflects the speed information in radar tracking processing. In the case of this object detection apparatus, as the number of interfaces between the apparatus and the own vehicle increases, manufacturing cost increases due to an increase in hardware scale or the like.

Here, a description will be given of a hardware configuration of the radar signal processor 3 serving as the radar signal processing unit, the camera image processor 4 serving as the camera image processing unit, and the fusion processor 5 serving as the fusion processing unit included in the object detection apparatus 100. Hereinafter, the radar signal processor 3, the camera image processor 4, and the fusion processor 5 are collectively referred to as a data processing unit. The data processing unit of the object detection apparatus 100 is implemented by processing circuitry. The processing circuitry may be a memory and a processor that executes a program stored in the memory, or may be dedicated hardware such as a dedicated circuit. The processing circuitry is also referred to as a control circuit.

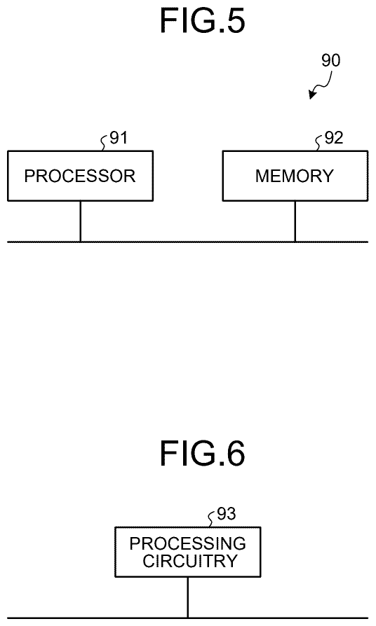

FIG. 5 is a diagram illustrating an exemplary configuration of processing circuitry included in the object detection apparatus according to the embodiment, the processing circuitry being implemented by a processor and a memory. Processing circuitry 90 illustrated in FIG. 5 is a control circuit, and includes a processor 91 and a memory 92. When the processing circuitry 90 includes the processor 91 and the memory 92, each function of the processing circuitry 90 is implemented by software, firmware, or a combination of software and firmware. The software or firmware is described as a program and stored in the memory 92. In the processing circuitry 90, the processor 91 reads and executes the program stored in the memory 92 to implement functions. That is, the processing circuitry 90 includes the memory 92 for storing a program. As a result of execution of the program, the data processing unit included in the object detection apparatus 100 is caused to perform processing. It can also be said that this program is a program for causing the object detection apparatus 100 to execute functions to be implemented by the processing circuitry 90. This program may be provided by means of a storage medium in which the program has been stored, or may be provided by other means such as a communication medium. It can also be said that the above-described program is a program for causing the data processing unit included in the object detection apparatus 100 to perform processing for detecting an object.

Examples of the processor 91 include a central processing unit (CPU) (also referred to as a processing device, an arithmetic device, a microprocessor, a microcomputer, or a digital signal processor (DSP)) and a system large-scale integration (LSI).

Furthermore, examples of the memory 92 include nonvolatile or volatile semiconductor memories such as a random access memory (RAM), a read only memory (ROM), a flash memory, an erasable programmable ROM (EPROM), and an electrically EPROM (EEPROM (registered trademark)), a magnetic disk, a flexible disk, an optical disk, a compact disk, a mini disk, and a digital versatile disc (DVD).

FIG. 6 is a diagram showing an example of the processing circuitry included in the object detection apparatus according to the embodiment, the processing circuitry including dedicated hardware. The processing circuitry 93 illustrated in FIG. 6 corresponds to, for example, a single circuit, a composite circuit, a programmed processor, a parallel-programmed processor, an application specific integrated circuit (ASIC), a field-programmable gate array (FPGA), or a combination thereof. A part of the processing circuitry 93 may be implemented by dedicated hardware, and another part of the processing circuitry 93 may be implemented by software or firmware. Thus, the processing circuitry 93 can implement each of the above-described functions by means of dedicated hardware, software, firmware, or a combination thereof. Furthermore, the radar signal processor 3, the camera image processor 4, and the fusion processor 5 may be configured by use of separate processing circuitry. In addition, two of the radar signal processor 3, the camera image processor 4, and the fusion processor 5 may be configured by use of the above-described processing circuitry, and the remaining one may be configured by use of the above-described processing circuitry.

As described above, in the embodiment, the object detection apparatus 100 determines a stationary object among objects based on the camera detection position of a moving object and the object type of the moving object; calculates a speed of an own vehicle as an own vehicle speed based on the radar detection speed of the stationary object, the own vehicle being a vehicle in which an own apparatus is installed; and causes the radar 1 to track the moving object and the stationary object based on the own vehicle speed. As a result, the object detection apparatus 100 can accurately detect an object.

The configurations set forth in the above embodiment show examples, and it is possible to combine the configurations with another known technique, and is also possible to partially omit or change the configurations without departing from the scope of the present disclosure.

### REFERENCE SIGNS LIST

1 radar; 2 camera; 3 radar signal processor; 4 camera image processor; 5 fusion processor; 6 position detection unit; 7 speed detection unit; 8 tracking processing unit; 9 radar detection data; 10 stationary object determination unit; 11 own vehicle speed detection unit; 12 object recognition unit; 13 camera detection data; 14 identity determination unit; 15 fusion detection data; 16 output unit; 20 vehicle control device; 21 radar horizontal coverage; 22 camera horizontal coverage; 30 vehicle; 41 to 43 memory; 100 object detection apparatus; A1 to C1 stationary object; X1 moving object.

1. An object detection apparatus comprising:
a radar to emit electromagnetic waves and receive reflected signals from objects including a moving object and a stationary object;
a camera to acquire image data on the objects by imaging the objects;
radar signal processing circuitry to detect radar detection positions and radar detection speeds by performing signal processing on the reflected signals, the radar detection positions being positions of the objects, the radar detection speeds being speeds of the objects;
camera image processing circuitry to detect camera detection positions and object types based on the image data, the camera detection positions being positions of the objects, the object types being types of some of the objects; and
fusion processing circuity to determine whether a position indicated by the radar detection position is identical to a position indicated by the camera detection position, and output the radar detection position, the radar detection speed, and the object type of the object to an external device, the object being determined to have identity, wherein
the camera image processing circuitry
detects the camera detection position of the moving object and the object type of the moving object, and
the radar signal processing circuitry
determines the stationary object among the objects based on the radar detection positions, the camera detection position of the moving object, and the object type of the moving object; calculates a speed of an own vehicle as an own vehicle speed based on the radar detection speed of the stationary object, the own vehicle being a vehicle in which an own apparatus is installed; and causes the radar to track the moving object and the stationary object based on the own vehicle speed.

2. The object detection apparatus according to claim 1, wherein
the camera image processing circuitry includes:
an object recognition circuitry to detect the camera detection position of the moving object and the object type of the moving object based on the image data, and
the radar signal processing circuitry includes:
position detection circuitry to detect the radar detection positions based on the reflected signals;
speed detection circuitry to detect the radar detection speeds based on the reflected signals;
stationary object determination circuitry to determine the radar detection speed of the stationary object based on the radar detection positions, the camera detection position of the moving object, and the object type of the moving object, the radar detection speed of the stationary object being among the radar detection speeds detected by the speed detection circuitry;
own vehicle speed detection circuitry to calculate the own vehicle speed based on the radar detection speed of the stationary object; and
tracking processing circuitry to perform processing for tracking the moving object and the stationary object with different parameters, based on the radar detection positions detected by the position detection circuitry, the radar detection speeds detected by the speed detection circuitry, and the own vehicle speed.

3. The object detection apparatus according to claim 1, wherein
the fusion processing circuitry includes:
identity determination circuitry to acquire the camera detection position of the moving object and the object type of the moving object from the camera image processing circuitry, acquire the radar detection position of the stationary object and the radar detection speed of the stationary object from the radar signal processing circuitry, and determine whether the object indicated by the radar detection position is identical to the object indicated by the camera detection position based on whether a position of the object indicated by the radar detection position is identical to a position of the object indicated by the camera detection position; and
output circuitry to output the radar detection position, the radar detection speed, and the object type of the object to an external device, the object being determined to have identity by the identity determination circuitry.

4. The object detection apparatus according to claim 2, wherein
the fusion processing circuitry includes:
identity determination circuitry to acquire the camera detection position of the moving object and the object type of the moving object from the camera image processing circuitry, acquire the radar detection position of the stationary object and the radar detection speed of the stationary object from the radar signal processing circuitry, and determine whether the object indicated by the radar detection position is identical to the object indicated by the camera detection position based on whether a position of the object indicated by the radar detection position is identical to a position of the object indicated by the camera detection position; and
output circuitry to output the radar detection position, the radar detection speed, and the object type of the object to an external device, the object being determined to have identity by the identity determination circuitry.
